(19) United States
(12) Patent Application Publication
(10) Pub. No.: US 2013/0254673 A1
(43) Pub. Date: Sep. 26, 2013

(54) AGENT SERVICE METHOD, AND ELECTRONIC DEVICE, SERVER, AND COMPUTER-READABLE RECORDING MEDIUM THEREOF

(71) Applicant: SAMSUNG ELECTRONICS CO., LTD., Suwon-si (KR)

(72) Inventors: Ju-youn LEE, Seongnam-si (KR); Dong-woo KIM, Daegu (KR); Young-ri KIM, Suwon-si (KR); Lindsey YOO, Yongin-si (KR); Sang-ok CHA, Daegu (KR)

(73) Assignee: SAMSUNG ELECTRONICS CO. LTD., Suwon-si (KR)

(21) Appl. No.: 13/791,116

(22) Filed: Mar. 8, 2013

(30) Foreign Application Priority Data
Mar. 20, 2012 (KR) 10-2012-0028417

(51) Int. Cl. G06F 3/0481

(52) U.S. Cl. CPC G06F 3/0481
USPC 715/739

(57) ABSTRACT

An agent service method and an electronic device are provided. The agent service method includes displaying an additional contacts list that is received from at least one of at least one contact server and at least one agent registration server in response to a contact addition request using the electronic device, adding first contact target information to a contacts list of the electronic device in response to a registration request for the first contact target information that is selected from among the additional contacts list, and performing an agent service with respect to user's input information of a user of the electronic device via a communication channel between the electronic device and the at least one contact server or between the electronic device and the at least one agent executing server according to second contact target information that is selected from the contacts list.

### PRIORITY

This application claims the benefit under 35 U.S.C. §119(a) of a Korean patent application filed on Mar. 20, 2012 in the Korean Intellectual Property Office and assigned Ser. No. 10-2012-0028417, the entire disclosure of which is hereby incorporated by reference.

### BACKGROUND OF THE INVENTION

1. Field of the Invention

The present invention relates to an agent service method using an electronic device. More particularly, the present invention relates to an electronic device, a server, and a computer-readable recording medium thereof

2. Description of the Related Art

Functions of electronic devices, including a smart phone, a handheld Personal Computer (PC), a tablet PC, and other similar portable electronic devices are being used by an increasing number of consumers and are becoming increasingly diversified. Accordingly, many methods have been studied to easily use various functions of the electronic devices. An agent service is one of the many methods.

However, a service range of a conventional agent service is preset. Thus, it is difficult for the conventional agent service to provide a user-customized agent service. For example, in a case where a user wants to search for particular information of an Information Technology (IT) field whereas an information search range of the conventional agent service is set to be a general-purpose, a search result provided to the user includes general information and thus, is not customized with search results relating to the IT field.

### SUMMARY OF THE INVENTION

Aspects of the present invention are to address at least the above-mentioned problems and/or disadvantages, and to provide at least the advantages described below. Accordingly, an aspect of the present invention is to provide a user-customized agent service method allowing a user to select a range of an agent service, and an electronic device, a server, and a computer-readable recording medium for the user-customized agent service method.

In accordance with an aspect of the present invention, an agent service method in an electronic device is provided. The agent service method includes displaying an additional contacts list that is received from at least one of at least one contact server and at least one agent registration server in response to a contact addition request using the electronic device, adding first contact target information to a contacts list of the electronic device in response to a registration request for the first contact target information that is selected from among the additional contacts list, and performing an agent service with respect to user's input information of a user of the electronic device via a communication channel between the electronic device and the at least one contact server or between the electronic device and at least one agent executing server according to second contact target information that is selected from the contacts list, wherein each of the additional contacts list, the first contact target information, and the second contact target information includes at least one piece of agent information.

In accordance with another aspect of the present invention, an agent service method in a mobile terminal is provided. The agent service method includes registering at least one piece of agent information to a friends list included in the mobile terminal by using a friend addition function of a contacts application that is set in the mobile terminal, the at least one piece of agent information being registered in at least one of at least one Social Network Service (SNS) server and at least one agent registration server, executing an external application of the contacts application, and retrieving the friends list, and performing an agent service with respect to user's input information according to the external application via a communication channel between the mobile terminal and at least one agent that is based on the at least one piece of agent information selected from the friends list and that is included in at least one of the at least one SNS server and the at least one agent executing server.

In accordance with another aspect of the present invention, an electronic device is provided. The electronic device includes a display unit for displaying a screen in response to user's input information, at least one processor for providing a user interface according to the user's input information and the display unit, a communication unit for communicating with at least one contact server, at least one agent registration server, and at least one agent executing server, and a storage unit for storing at least one program to be executed by the at least one processor, and a contacts list, wherein the at least one program includes a command to display an additional contacts list that is received from the at least one contact server or the at least one agent registration server in response to a contact addition request, a command to add first contact target information to the contacts list in response to a registration request for the first contact target information that is selected from the additional contacts list, and a command to perform an agent service according to a user's input information via a communication channel with the at least one contact server or with the at least one agent executing server, according to second contact target information that is selected from the contacts list, and wherein each of the additional contacts list, the first contact target information, and the second contact target information includes at least one piece of agent information.

In accordance with another aspect of the present invention, an agent service method in a server is provided. The agent service method includes transmitting an additional contacts list to at least one electronic device in response to a contact addition request signal received from the at least one electronic device, and performing an agent service with respect to user's input information received from the at least one electronic device by using at least one agent that is from among a plurality of agents and that corresponds to at least one piece of agent information comprised in contact target information received from the at least one electronic device.

In accordance with another aspect of the present invention, an agent service method in a server is provided. The agent service method includes transmitting an additional contacts list to at least one electronic device in response to a contact addition request signal received from the at least one electronic device, and performing an agent service with respect to user's input information received from the at least one electronic device by using an agent that is from among a plurality of agents and that corresponds to agent information included in contact target information received from the at least one electronic device.

In accordance with another aspect of the present invention, a server is provided. The server includes a communication unit for communicating with at least one electronic device, a plurality of agents each performing an agent service with respect to a user's input information that is received via the communication unit, at least one processor for controlling the communication unit and the plurality of agents, and a storage unit for storing an additional contacts list and at least one program that is configured to be executed by the at least one processor, wherein the at least one program comprises one or more commands to transmit the additional contacts list read from the storage unit to the at least one electronic device in response to a contact addition request signal that is received from the at least one electronic device via the communication unit, wherein the agent service is performed with respect to a user's input information received from the at least one electronic device, by using at least one agent that is from among the plurality of agents and that corresponds to at least one piece of agent information comprised in contact target information received from the at least one electronic device via the communication unit.

In accordance with another aspect of the present invention, an agent service method in a mobile terminal is provided. The agent service method includes executing a contacts application that is set in the mobile terminal, transmitting a friend addition request signal to at least one of at least one contact server and at least one agent registration server according to a friend addition request using a friend addition function of the contacts application, receiving an additional friends list from at least one of the at least one contact server and the at least one agent registration server, displaying the additional friends list on the mobile terminal, and adding at least one piece of agent information to a friends list stored in the mobile terminal according to a selection and registration request for the at least one piece of agent information included in the additional friends list, wherein the additional friends list includes at least one new agent information and at least one new friend information.

In accordance with another aspect of the present invention, an agent service method in a mobile terminal is provided. The agent service method includes executing an application that is set in the mobile terminal and that includes a friends list retrieve function, displaying a friends list stored in the mobile terminal according to an execution request for the friends list fetch function, transmitting at least one piece of agent information to at least one of at least one contact server and at least one agent registration server according to selection for the at least one piece of agent information based on the friends list, transmitting user's input information according to the executed application to at least one of the at least one contact server and the at least one agent registration server, and displaying a response signal on the mobile terminal, wherein the response signal corresponds to a user's input information and is received from at least one of the at least one contact server and the at least one agent registration server.

In accordance with another aspect of the present invention, an agent service system is provided. The agent service system includes an electronic device that adds at least one piece of agent information to a contacts list by using an additional contacts list and that performs an agent service by using the at least one piece of agent information selected according to the contacts list, an agent registration server having a plurality of agents and that transmits an additional contacts list including information of the plurality of agents to the electronic device in response to a contact addition request signal received from the electronic device, at least one agent execution server that forms a communication channel with the electronic device by using the at least one piece of agent information received from the electronic device, and that provides an agent service with respect to a user's input information received from the electronic device via the communication channel, wherein the contacts list of the electronic device includes at least one piece of agent information and at least one acquaintance information.

In accordance with another aspect of the present invention, a computer-readable recording medium having recorded thereon at least one program is provided. The computer-readable recording medium includes commands to perform the agent service method in the electronic device.

In accordance with another aspect of the present invention, a computer-readable recording medium having recorded thereon at least one program is provided. The computer-readable recording medium includes commands to perform the agent service method in the server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a network configuration arranged to provide an agent service according to an exemplary embodiment of the present invention;

FIG. 2 is a block diagram of an electronic device for the agent service according to an exemplary embodiment of the present invention;

FIG. 3 is a flowchart of an agent service method performed by the electronic device according to an exemplary embodiment of the present invention;

FIGS. 4 through 6 are diagrams illustrating a process of adding agent information to a contacts list according to a registration request in the agent service method according to exemplary embodiments of the present invention;

FIG. 7 is a flowchart of a process of adding agent information to a contacts list in an agent service method according to an exemplary embodiment of the present invention;

FIG. 8 is a flowchart of an agent service process using a friends list including agent information in an agent service method according to an exemplary embodiment of the present invention;

FIG. 9 is a block diagram of a contact server according to an exemplary embodiment of the present invention;

FIG. 10 is a flowchart of an agent service method performed by a contact server according to an exemplary embodiment of the present invention;

FIG. 11 is a flowchart of an agent service method performed by a contact server according to an exemplary embodiment of the present invention;

FIG. 12 illustrates an example of a screen based on an agent service method according to an exemplary embodiment of the present invention;

FIG. 13 is a signal flow in the network of FIG. 1, which corresponds to a case in which a contact target includes only an agent as shown in FIG. 12;

FIG. 14 illustrates examples of other screens based on an agent service method according to another exemplary embodiment of the present invention;

FIGS. 15 through 20 illustrate examples of other screens based on an agent service method according to another exemplary embodiment of the present invention;

FIG. 21 is a signal flowchart among configuring elements of the network of FIG. 1 when the agent service shown in FIG. 20 is performed; and

FIG. 22 illustrates a network configuration arranged to provide an agent service according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While terms “first” and “second” are used to describe various components, it is obvious that the components are not limited to the terms “first” and “second”. The terms “first” and “second” are used only to distinguish between each component.

Furthermore, all examples and conditional language recited herein are to be construed as being without limitation to such specifically recited examples and conditions. Terms used in the specification are widely-used general terms in consideration of their functions in the specification, however, the terms may vary according to the objective of the descriptor, leading cases, or new technologies. Also, some terms are arbitrarily selected by the applicant and in this case, the meaning of the terms will be described in detail in the specification. Thus, terms used in the specification have to be defined based on the meanings of the terms and their descriptions in the specification, not just based on names of the terms.

Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

Throughout the specification, an agent may indicate a program or an application that processes functions intended by a user according to a user's command or user's input information. For example, the agent may process a function to provide information found in response to the user's input information, to answer questions by the user, to translate the user's input information, or to control other applications or devices in response to the user's input information. However, the present invention is not limited thereto, and functions of the agent may provide other services related to a program or an application.

Agent information may indicate information, such as a name of the agent, that implicatively represents functions of the agent. For example, when the agent has a function to control a smart TV, the agent information may be expressed as “smart TV” or “smart TV control”.

An agent service may indicate a service provided to a user based on a function of the agent. For example, when the function of the agent is “to provide specialized information of an Information Technology (IT) field”, the agent service may provide the user with specialized information of the IT field which is searched for based on user's input information.

Throughout the specification, the user's input information may include a user's question or a user's command with respect to the agent. The user's input information may be generated as at least one of a natural language-based voice signal, a natural language-based text message, and multimedia information, or any other suitable and/or similar method of inputting information according to an executed application. The multimedia information may include image information and audio information.

In a case where the executed application is a dialing application, the user's input information may be generated as the natural language-based voice signal. In a case where the executed application is a text transmission application, the user's input information may be generated as one of the multimedia information and the natural language-based text message.

A contact server and/or an agent executing server may have a function to process and generate natural language. Herein, natural language processing may refer to a morphological analysis, a meaning analysis, a conversation analysis, or any other similar and/or suitable form of language analysis and/or processing that are performed on the user's input information, so that the user's input information is converted into data that can be processed by the agent. Herein, natural language generation may refer to a result processed by the agent that is generated as text, voice, an image, or the like, which is recognizable to the user. In a case where the agent aims to control a device or an application, the result processed by the agent may be generated as a signal to control the device or the application. As described above, when the result processed by the agent is the signal to control the device or the application, the contact server or the agent executing server may generate a device control signal or an application control signal as a result according to the generation of the natural language.

According to an executed application, the user's input information may be generated as information conforming to a format that is requested by the application. For example, when the executed application is a calendar management application, the user's input information may be generated as information that is input according to a format requested by the calendar management application. In this case, the user's input information may also include a natural language-based text message.

Throughout the specification, an application may be any one of applications capable of using a function to fetch a contacts list, such as a phone call, text transmission, calendar management, or the like, a contacts application, and any other similar and/or suitable application type. The contacts application may be an application that manages information of at least one acquaintance that the user may contact. For example, a telephone book application may be included in the contacts application.

Thus, the contacts application may be used to register information of a user-selected agent and information of a user-selected acquaintance to the contacts list. In a case where the contacts application is the telephone book application, the contacts list may be a telephone numbers list. Except for the contacts application, an application that may use the function to fetch the contacts list is referred to as an external application of the contacts application. The function to fetch the contacts list in the external application may be referred to as a sub contact module. The contacts application and the external application may be applications that are set in an electronic device.

Throughout the specification, a request or selection may depend on a user's gesture. The user's gesture may be defined according to input devices. That is, when the input device is based on a touch screen, the user's gesture may include a tap, touch-and-hold, a double-tap, a drag, panning, a flick, drag-and-drop, a sweep, and any other similar and/or suitable gesture. The user's gesture based on a touch screen may be performed by using a user's finger, a touch tool (e.g., a stylus pen), or any other object or element that is suitable for inputting the user's gesture.

Hereinafter, the present invention will be described in detail by explaining exemplary embodiments of the invention with reference to the attached drawings. Like reference numerals in the drawings denote like elements and detailed descriptions thereof are omitted.

As used herein, the term “and/or” includes any and all combinations of one or more of the associated listed items.

Expressions such as “at least one of,” when preceding a list of elements, modify the entire list of elements and do not modify the individual elements of the list.

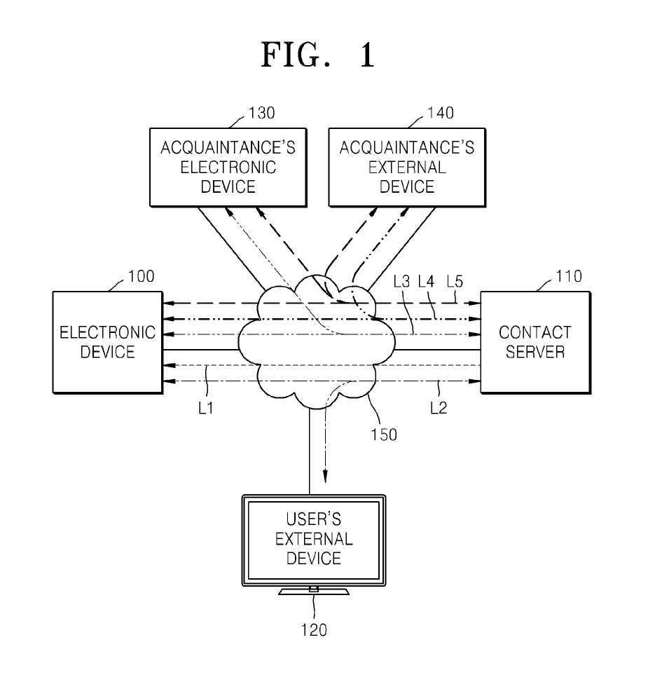

FIG. 1 illustrates a network configuration arranged to provide an agent service according to an exemplary embodiment of the present invention.

The network configuration of FIG. 1 includes an electronic device 100, a contact server 110, a user's external device 120, an acquaintance's electronic device 130, an acquaintance's external device 140, and a network 150. However, the present invention is not limited thereto, and a network configuration arranged to provide the agent service is not limited to that of FIG. 1, and may be any suitable and/or similar network configuration. For example, the network configuration arranged to provide the agent service may include a plurality of devices in at least one device from among the user's external device 120, the acquaintance's electronic device 130, the acquaintance's external device 140, and the contact server 110. Alternatively, the network configuration arranged to provide the agent service may consist of the electronic device 100 and the contact server 110.

The electronic device 100 and the acquaintance's electronic devices 130 are devices capable of performing communication in a wired or wireless manner. Examples of the electronic device 100 and the acquaintance's electronic devices 130 may include a smart phone, a smart TV, a Personal Computer (PC), a desktop PC, a notebook, a smart board, a tablet PC, a mobile terminal, a handheld device, a handheld computer, a media player, a Personal Digital Assistant (PDA), and any other similar and/or suitable electronic device and/or apparatus. The electronic device 100 and the acquaintance's electronic devices 130 may be different from each other. For example, the electronic device 100 may be a smart phone, and the acquaintance's electronic devices 130 may be a tablet PC.

The user's external device 120 may be a user's device other than the electronic device 100 of the user. The acquaintance's external device 140 may be an acquaintance's device other than the acquaintance's electronic devices 130. The user's external device 120 and the acquaintance's external device 140 may be the same type of devices or different types of devices. For example, the user's external device 120 may be a TV having a communication function, and the acquaintance's external device 140 may be a health care terminal having a communication function.

As described above, the user's external device 120 and the acquaintance's external device 140 may include digital Consumer Electronic (CE) devices having a communication function. The digital CE devices may include a digital TV, an Internet Protocol (IP) TV, a refrigerator, an air conditioner, a printer, a health care terminal, and any other similar and/or suitable electronic devices that have a display function.

Thus, in the network 150, the electronic device 100 and the acquaintance's electronic devices 130 may be mobile terminals of different users, the user's external device 120 may be a smart TV of the user of the electronic device 100, which is capable of performing communication, the acquaintance's external device 140 may be a health care terminal of an acquaintance, which is capable of performing communication, and the contact server 110 may be a Social Network Service (SNS) server to which one or more agents are registered.

When the electronic device 100 is a mobile terminal, the agents registered to the contact server 110 may include an agent to control an application set in the mobile terminal, an agent to answer a user's question input through the mobile terminal, an agent to control a function of the smart TV of the user, an agent to provide information according to a user's request, wherein the information is collected by the health care terminal, or other similar and/or suitable external device of the acquaintance. The agent to control the application may be registered to the contact server 110 according to each application.

The electronic device 100 of FIG. 1 may include the agent service. That is, the electronic device 100 adds information of at least one agent to a contacts list, which is selected by the user via communication with the contact server 110 based on a contacts application set in the electronic device 100. Also, the electronic device 100 may provide the user with an agent service with respect to user's input information via communication with the contact server 110 by using the information of at least one agent selected based on the contacts list in execution of an external application.

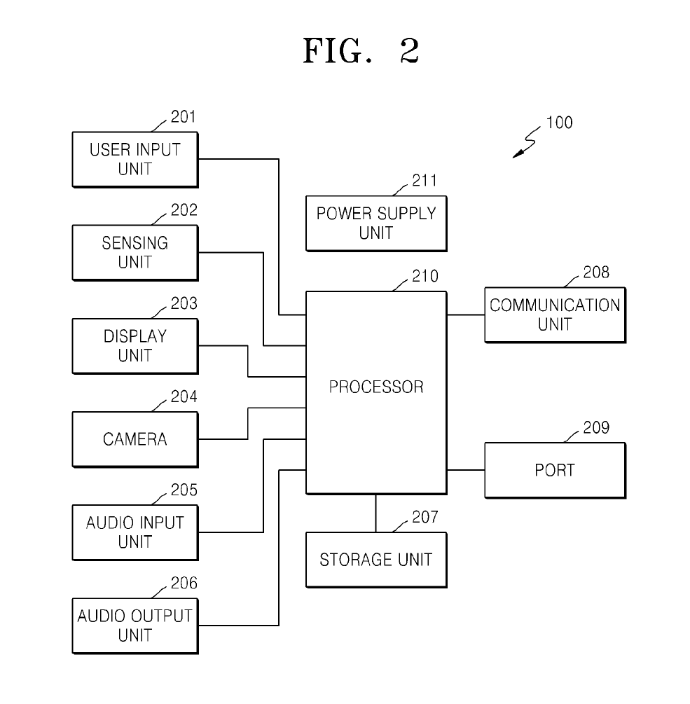

FIG. 2 is a block diagram of an electronic device for an agent service according to an exemplary embodiment of the present invention.

Referring to FIG. 2, the electronic device 100 may include a user input unit 201, a sensing unit 202, a display unit 203, a camera 204, an audio input unit 205, an audio output unit 206, a storage unit 207, a communication unit 208, a port 209, a processor 210, and a power supply unit 211. However, the present invention is not limited to the configuration of the electronic device 100 as shown in FIG. 2, the electronic device 100 may be configured in any suitable and/or similar manner. The acquaintance's electronic device 130 may also include configuring elements of the electronic device 100 of FIG. 2, however, the configuring elements of the acquaintance's electronic device 130 are not limited thereto.

The user input unit 201 generates input data, which may be control data, and the user's input information that are used to control an operation of the electronic device 100. The user input unit 201 may include a keypad, a dome switch, a touch panel, a jog wheel, a jog switch, a hardware button, or any other similar and or suitable input device. In a case where the touch panel is used to perform functions associated with a mouse, the touch panel may be a touch pad. However, in a case where the touch panel forms a mutual layer structure with the display unit 203, as will be described below, the touch panel may be a touch screen. The touch screen may be a resistance film type (pressure sensing type) touch screen, a capacitive touch screen, and/or any other similar and/or suitable type of touch screen.

When the user input unit 201 is the touch screen that forms the mutual layer structure with the display unit 203, the input data may be generated according to a user's request or user's selection according to a user's gesture. When the user input unit 201 is the touch screen, the user's gesture may be variously defined according to a variety of parameters, such as a touch count, a touch pattern, a touch area, a touch strength, or any other similar and/or suitable parameter, and a combination thereof When the user input unit 201 is the touch screen, a touch by a user's finger may be assumed when a touch by a user's body part that touches a touch area of the user input unit 201 occurs.

The sensing unit 202 senses a current status of the electronic device 100, wherein the current status may be a location of the electronic device 100, an occurrence of a contact by the user, a direction of the electronic device 100, acceleration or retardation of the electronic device 100, or any other similar and/or suitable status, and then generates a sensing signal to control the operation of the electronic device 100 according to the sensed current status of the electronic device 100.

Also, the sensing unit 202 may include various sensors to sense a touch or a proximity touch to the touch panel. A sensor to sense the touch to the touch panel may be assumed to be included in the touch screen in a case where the user input unit 201 is the touch screen that forms the mutual layer structure with the display unit 203. This is because the sensor to sense the touch to the touch panel indicates a sensor that senses the user's gesture or a pattern on the touch panel, and generates a signal obtained by sensing a drag, a flick, a tap, touch-and-hold, a double-tap, panning, a sweep, and any other similar and/or suitable gestures that are recognized as the user's gesture on the touch panel.

The sensor to sense the touch to the touch panel may be a tactile sensor, or any other similar and/or suitable type of sensor. The tactile sensor may sense various information including roughness of a contact surface, hardness of a contact object, temperature of a contact point, or other similar information. A proximity sensor may be a sensor that detects an object that approaches a preset detection surface or that detects an object existing in an adjacent area, without a mechanical or physical contact, by using an electro-magnetic field, infrared rays, or any other similar and/or suitable property. An example of the proximity sensor includes a transmission-type photoelectric sensor, a direct reflection-type photoelectric sensor, a mirror reflection-type photoelectric sensor, a high frequency oscillation proximity sensor, a capacity-type proximity sensor, a magnetic proximity sensor, an infrared ray proximity sensor, and any other similar and/or suitable sensor.

The touch to the touch panel may be a case in which a pointer touches the touch panel. The touch may include multiple touches. The proximity touch to the touch panel may be a case in which the pointer does not actually touch the touch panel but approaches within a predetermined distance from the touch panel. The pointer is a device used to touch or proximately touch a specific area of the touch panel. The pointer may be any one of a stylus pen, a finger, a human body part corresponding to a finger, a device corresponding to a finger, and any other similar and or suitable device or element. Thus, the pointer may be referred to as an external input device.

The display unit 203 outputs information processed by the electronic device 100. For example, the display unit 203 displays a screen in response to the user's gesture or the touch pattern as sensed by the sensing unit 202, or in response to the control data or the user's input information, which is input via the user input unit 201. When the user input unit 201 is the touch panel, the user's gesture or the touch pattern may correspond to one of the control data and the user's input information, which is input via the user input unit 201.

When the display unit 203 is the touch screen that forms the mutual layer structure with the user input unit 201, the display unit 203 may be an Input/Output (I/O) device. When the display unit 203 is the I/O device, the screen displayed on the display unit 203 may include a User Interface (UI) screen or a Graphic UI (GUI) screen. The display unit 203 may be any and/or at least one of a Liquid Crystal Display (LCD), a Thin Film Transistor LCD (TFT LCD), an Organic Light-Emitting Diode (OLED) display, a flexible display, a three-Dimensional (3D) display, an Active-Matrix (AM) OLED display, and any other similar and/or suitable display device. According to a configuration of the electronic device 100, the display unit 203 may include at least two displays.

The camera 204 processes an image frame, such as a still image and a moving picture, which is obtained by an image sensor in a video telephony mode, a photography mode or any other mode for capturing still and/or moving images. The processed image frame may be displayed on the display unit 203. The image frame processed by the camera 204 may be stored in the storage unit 207 or may be externally transmitted via the communication unit 208 or the port 209. The camera 204 may include any suitable number of cameras. Also, the camera 204 may be used as an input device that recognizes a user's spatial gesture, face, Quick Response (QR) code, or any other similar and or suitable information that is input via the camera 204.

The audio input unit 205 receives an audio signal from an external source, such as a user, when operating in a telephone mode, a record mode, or an audio recognition mode, converts the received audio signal into electrical audio data, and then, transmits the electrical audio data to the processor 210. The audio input unit 205 may be a microphone. The audio input unit 205 may include various noise reduction algorithms so as to remove noise that occurs when the audio input unit 205 receives the audio signal from the outside. The audio signal that is input via the audio input unit 205 may include the user's input information for the agent service. The audio signal input via the audio input unit 205 may be stored in the storage unit 207 or may be externally transmitted via the communication unit 208 or the port 209.

According to an interface function between the electronic device 100 and the user, the user input unit 201, the sensing unit 202, the display unit 203, the camera 204, and the audio input unit 205 may be referred to as input devices or I/O devices. For example, when the interface function between the electronic device 100 and the user includes a touch screen function, an audio recognition function, and a spatial gesture recognition function, the user input unit 201, the sensing unit 202, the camera 204, and the audio input unit 205 may be referred to as input devices, and the display unit 203 may be referred to as an I/O device. The audio output unit 206 may output an audio signal when operating in the telephone mode or an audio play mode, or any other mode that involves outputting audio signals. The audio output unit 206 may be a speaker. The audio input unit 205 and the audio output unit 206 may be integrally formed as a headset or in any suitable manner.

The storage unit 207 stores one or more programs and resources that may be executed by the processor 210. The one or more programs may include a program to execute the agent service method, an operating system program of the electronic device 100, an application set in the electronic device 100, and programs required to perform various functions (e.g. a communication function and a display function) of the electronic device 100, or any other suitable and or similar program.

The resources may include the contacts list for one or more exemplary embodiments of the present invention, information used to operate the application set in the processor 210, and information used to execute the one or more programs to perform the various functions.

The storage unit 207 may be divided into a storage unit to store the one or more programs to execute the operating system program of the electronic device 100 and to perform the various functions of the electronic device 100, and a storage unit to store the one or more programs and the resources to execute the agent service method and the applications. The storage unit 207 may include a non-volatile memory including a high-speed Random Access Memory (RAM), a magnetic disc storage device, a flash memory, a non-volatile semiconductor memory, or any other similar and/or suitable non-transient storage medium. The storage unit 207 may be referred to as a memory.

The communication unit 208 is configured to exchange data with the contact server 110 and the acquaintance's electronic devices 130 via a wireless network, such as a wireless Internet, a wireless intranet, a wireless phone network, a wireless Local Area Network (LAN), Wi-Fi, Wi-Fi Direct (WFD), 3rd-Generation (3G), 4th-Generation (4G) Long Term Evolution (LTE), Bluetooth, Infrared Data Association (IrDA), Radio Frequency IDentification (RFID), Ultra-Wide Band (UWB), ZigBee, Near Field Communication (NFC), or any other similar and/or suitable wireless communication system, or a wired network, such as a wired internet, or any other similar and/or suitable wired communication system. The communication unit 208 may include at least one of a broadcasting receiving module, a mobile communication module, a wireless internet module, a wired internet module, a NFC module, and a location information module. However, the present invention is not limited thereto, and the communication unit 208 may be and/or include any suitable and or similar communication device, module or element.

The broadcasting receiving module receives a broadcasting signal and/or broadcasting-related information from an external broadcasting management server via a broadcasting channel. The broadcasting channel may include a satellite channel and a terrestrial channel. The mobile communication module exchanges a wireless signal with at least one of a base station in a mobile communication network, an external terminal (e.g., the acquaintance's electronic device 130), a server (e.g., the contact server 110), or any other similar and/or suitable device and/or element. The wireless signal may include various types of data according to a transmission and/or a reception of an audio-call signal, an image-call signal, text/multimedia messages, or any other similar and/or suitable signal or message. The wireless internet module may be a module for connection to wireless Internet. The wired internet module may be a module for connection to wired Internet.

The NFC module may be a module for near field communications and/or communications within limited proximity The NFC module may execute Bluetooth, RFID, IrDA, UWB, ZigBee, WFD, NFC, and any other similar and/or suitable communication system. The location information module is a module to check or obtain a location of the electronic device 100. For example, the location information module may include a Global Positioning System (GPS) module. The GPS module may receive location information from a plurality of satellites. The location information may include coordinates information expressed as latitude and longitude.

The port 209 may exchange data with an external device including the user's external device 120, by using a plug-and-play interface such as a Universal Serial Bus (USB) port (not shown). The plug-and-play interface indicates a module that automatically plays when the external device is put into a plug of the electronic device 100.

The power supply unit 211 supplies power to various configuring elements of the electronic device 100. The power supply unit 211 includes one or more power sources such as a battery, a Direct Current (DC), and an Alternating Current (AC) power source. According to an exemplary embodiment of the present invention, the electronic device 100 may be configured so as to not include the power supply unit 211, but rather, may include a connection unit (not shown) that may be connected to an external power supply unit (not shown).

The processor 210 may be one or more processors to control an overall operation of the electronic device 100. The processor 210 may be divided into a plurality of processors according to functions of the electronic device 100 or may be in any suitable form for processing operations of the electronic device 100.

The processor 210 may control the user input unit 201, the sensing unit 202, the display unit 203, the camera 204, the audio input unit 205, the audio output unit 206, the storage unit 207, the communication unit 208, and the port 209, and any other elements included in the electronic device 100. Thus, the processor 210 may be referred to as a controller, a micro-processor, a digital signal processor, or the like. Also, the processor 210 may provide the user's input information input by using the user input unit 201, the sensing unit 202, the camera 204, and the audio input unit 205 that correspond to input devices, and a user interface based on the display unit 203.

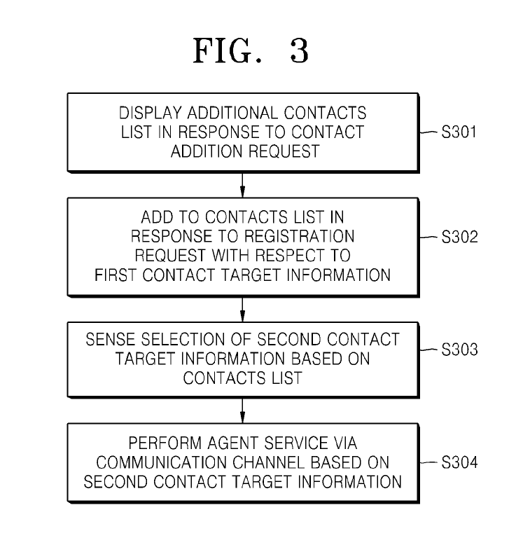

The processor 210 may execute one or more programs related to the agent service method. The processor 210 may read the one or more programs from the storage unit 207 and may execute them or may download the one or more programs from an external device, such as an application providing server (not shown) or a market server (not shown), which is connected via the communication unit 208 and may execute them. The processor 210 may include an interface function unit between function modules included in the electronic device 100 and the processor 210. Operations of the processor 210 which are related to the agent service method may be performed as shown in a flowchart of FIG. 3.

FIG. 3 is a flowchart of an agent service method performed by an electronic device according to an exemplary embodiment of the present invention.

Referring to FIG. 3, in operation S301, the processor 210 may display an additional contacts list on the display unit 203, wherein the additional contacts list is received from the contact server 110 in response to a contact addition request by a user. The additional contacts list may include at least one piece of agent information and at least one piece of acquaintance information. The at least one piece of agent information and the at least one piece of acquaintance information included in the additional contacts list may be new information that does not overlap or is not redundant with information that is included in a contacts list stored in the storage unit 207.

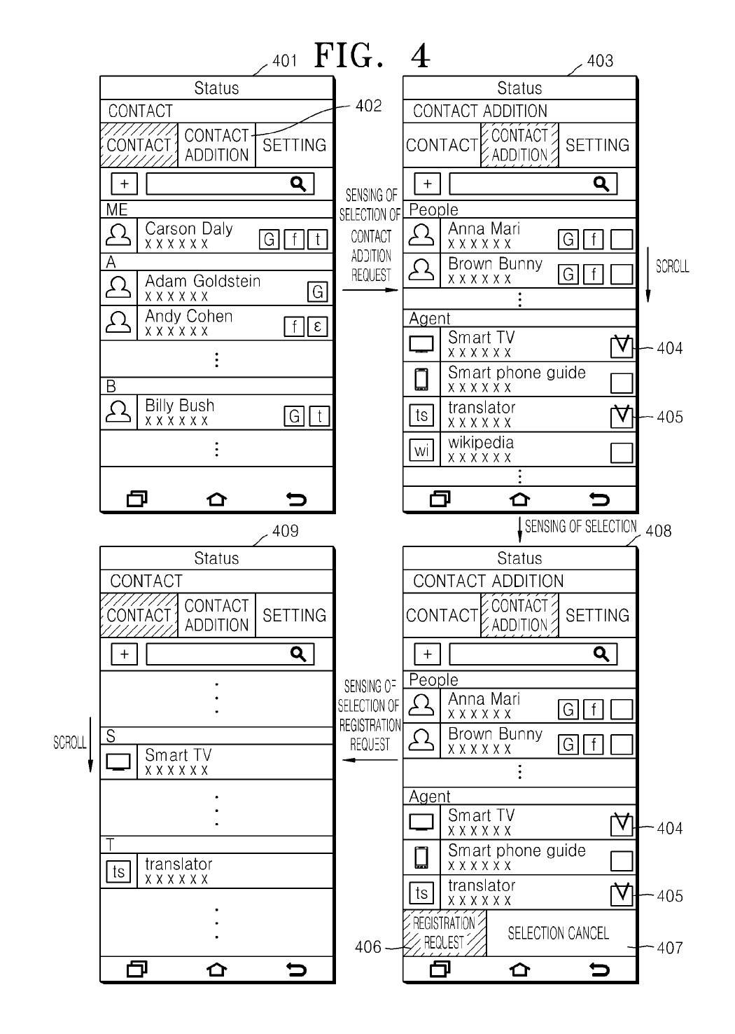

The contact addition request may indicate that the user wants to add a new contact target to the contacts list stored in the storage unit 207. The contact addition request may occur in a way described below with reference to FIGS. 4 through 6 and may be provided to the processor 210. When the contact server 110 is an SNS server, the contact addition request may be synchronized with a friend addition request of an SNS. The synchronization may be set in advance due to synchronization between the electronic device 100 and an account of the user of the electronic device 100 in the SNS server. The remaining operations of FIG. 3 will be discussed below with reference to FIGS. 4 through 6.

FIGS. 4 through 6 are diagrams illustrating a process of adding agent information to a contacts list according to a registration request in the agent service method according to exemplary embodiments of the present invention.

Referring to FIG. 4, a screen 401 includes a contacts list that is displayed on the display unit 203 according to a contacts application execution request executed by a user. When a user's gesture or a user's touch that is for selecting a contact addition item 402 included in the screen 401 is sensed, then the processor 210 may determine that a contact addition request by the user occurs.

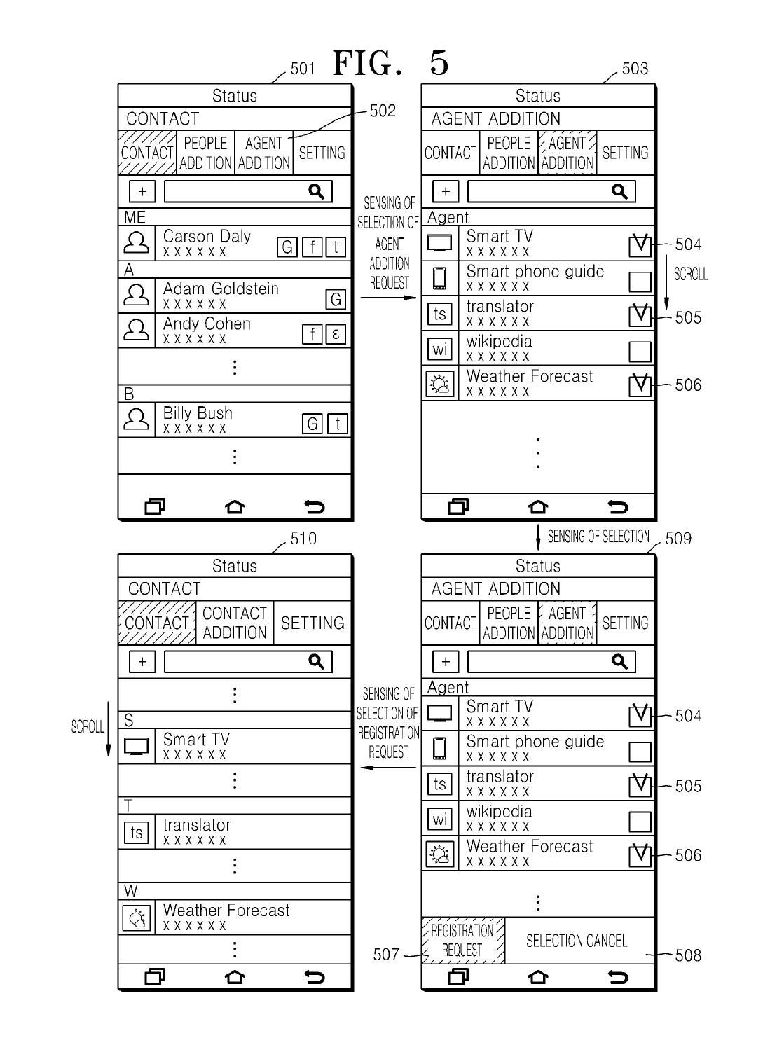

Referring to FIG. 5, a screen 501 includes a contacts list that is displayed on the display unit 203 according to the contacts application execution request executed by the user. The screen 501 illustrates an example in which a person addition request and an agent addition request may be independently performed. The person addition request may be for a friend addition based on SNS members. When a user's gesture or a user's touch that is for selecting an agent addition item 502 in the screen 501 is sensed, then the processor 210 determines that a contact addition request (or an agent addition request) by the user occurs. As shown in FIG. 5, the agent addition request may correspond to the contact addition request that is described in one or more exemplary embodiments of the present invention.

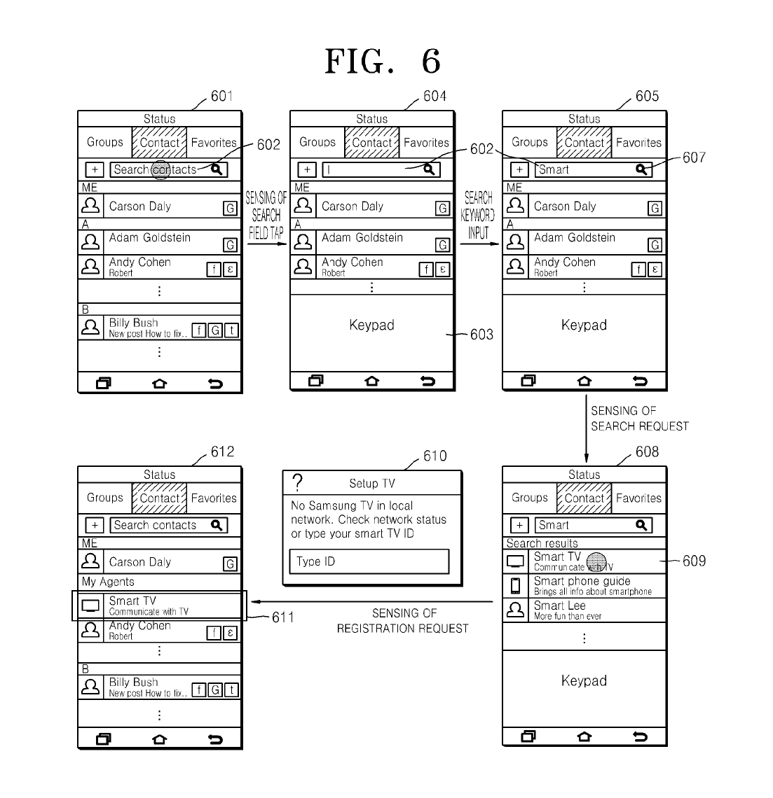

Referring to FIG. 6, a screen 601 includes a contacts list that is displayed on the display unit 203 according to the contacts application execution request by the user. When a user's gesture or a user's touch that is for selecting a search field 602 included in the screen 601 is sensed, the processor 210 changes the screen 601 that is displayed on the display unit 203 to a screen 604 that includes a virtual keypad 603. The screen 604 also includes the contacts list. When a search keyword “smart” is input through the virtual keypad 603 and is displayed on the search field 602 of a screen 605, and a user's gesture or a user's touch that is for selecting a search request 607 is sensed, then the processor 210 determines that the contact addition request occurs. The contact addition request in FIGS. 4 through 6 may occur in and/or may be executed using an audio recognition mode.

When the processor 210 determines the occurrence of the contact addition request, the processor 210 may transmit a contact addition request signal to the contact server 110 via the communication unit 208. When an additional contacts list is received from the contact server 110, the processor 210 may display the received additional contacts list on the display unit 203. As described above, operation S301 of FIG. 3 may include a process of transmitting the contact addition request signal from the electronic device 100 to the contact server 110, and may include a process of receiving the additional contacts list from the contact server 110 by the electronic device 100.

In FIG. 4, a screen 403 includes the additional contacts list. The screen 403 includes information of at least one person and information of at least one agent that are to be added to the contacts list. The information of at least one person may be information of an acquaintance who knows the user of the electronic device 100 from among the SNS members. Thus, persons displayed on the screen 403 may be referred to as friends, or may be any other suitable and/or similar person having contact information. A plurality of pieces of information of the additional contacts list which are not shown in the screen 403 may be shown by a user's gesture or a user's touch which corresponds to a scroll. In FIG. 5, a screen 503 includes the additional contacts list. The screen 503 includes information of at least one agent that is to be added to the additional contacts list. In FIG. 6, a screen 608 includes the additional contacts list that is provided based on the search keyword “smart”.

Referring again to FIG. 3, in operation S302, in response to a registration request with respect to first contact target information that is selected by the user according to the displayed additional contacts list, the processor 210 adds the first contact target information to the contacts list stored in the storage unit 207. The first contact target information includes the information of at least one agent. The contact target selection by the user and the registration request with respect to the selected contact target according to the additional contacts list may be performed by the user's gesture, by the user's touch, by an audio recognition technology, or by any other suitable action for inputting the contact target selection. Operation S302 of FIG. 3 will be described below in detail with reference to the screens shown in FIGS. 4 through 6.

In FIG. 4, when a user's gesture or a user's touch that is for selecting a smart TV agent item 404 and a translation agent item 405 in the screen 403 is sensed, then the processor 210 displays a screen 408 on the display unit 203. The screen 408 includes a registration request item 406 and a selection cancel item 407 which may be selected by the user. The registration request item 406 and a selection cancel item 407 may be displayed according to a user-selectable menu item request via the user input unit 201.

When a user's gesture or a user's touch that is for selecting the registration request item 406 in the screen 408 is sensed, then the processor 210 displays a screen 409, including a contacts list to which information of an agent selected by the user is added, on the display unit 203. As described above, when the information of the selected agent is added to the contacts list, the contacts list including the added agent information is automatically displayed on the display unit 203, so that the user may easily check an addition status with respect to agent information. When a user's gesture or a user's touch that is for selecting the selection cancel item 407 in the screen 408 is sensed, then the processor 210 displays a screen on the display unit 203, wherein mark information in check boxes 404 and 405 indicating an item selected by the user is deleted from the additional contacts list.

In FIG. 5, when a user's gesture or a user's touch that is for selecting a smart TV agent item 504, a translation agent item 505, and a weather forecast agent item 506 in the screen 503 is sensed, then the processor 210 displays a screen 509, including a registration request item 507 and a selection cancel item 508, on the display unit 203. Here, the registration request item 507 and the selection cancel item 508 may be displayed according to a user-selectable menu item request via the user input unit 201.

When a user's gesture or a user's touch that is for selecting the registration request item 507 in the screen 509 is sensed, then the processor 210 displays a screen 510 including a contacts list on the display unit 203, wherein the contacts list includes information of an agent selected by the user. When a user's gesture or a user's touch that is for selecting the selection cancel item 508 in the screen 509 is sensed, then the processor 210 displays a screen on the display unit 203, wherein mark information in check boxes 504, 505, and 506 indicating an item selected by the user is deleted from the additional contacts list.

In FIG. 6, when a user's gesture or a user's touch that is for selecting a smart TV agent item 609 in the screen 608 is sensed, and a smart TV agent needs additional information setting, then the processor 210 displays an additional information setting screen 610 on the display unit 203. The additional information setting screen 610 may be hierarchical according to additional information to be set. For example, an additional information setting screen requesting an input of smart TV owner information may be displayed and then, after the smart TV owner information is input, an additional information setting screen requesting an input of ID information regarding a smart TV for communication may be displayed and then, after the input of the ID information is checked, a hierarchical process may be ended. However, an example of the additional information setting screen 610 is not limited to the aforementioned hierarchical way, and the additional information setting screen 610 may be displayed in any suitable manner for receiving and/or displaying additional information.

The additional information may include information that may be used to set a communication channel for the agent service. For example, the additional information may include the ID information regarding the smart TV for the communication. The contents displayed on the additional information setting screen 610 are exemplary and thus the additional information setting screen 610 may have any suitable and/or similar contents and formats displayed thereon.

After the additional information is set, when a user's gesture or a user's touch that is for selecting a registration request with respect to a selected contact target is sensed, then the processor 210 displays a screen 612 including a contacts list on the display unit 203, wherein the contacts list includes user-selected agent information 611. The registration request may be the same as that described with reference to FIGS. 4 and 5. Also, the processor 210 links the additional information with information of the smart TV agent which is added to the contacts list, and then, stores the linked information in the storage unit 207. Accordingly, when the information of the smart TV agent is selected as a contact target for the agent service, the processor 210 may read the additional information linked to the information of the smart TV agent from the storage unit 207. Then, the processor 210 may transmit selected contact target information and the additional information linked to the selected contact target information to the contact server 110. The additional information may be included in the selected contact target information and then may be transmitted to the contact server 110.

When the additional information setting is not requested for the selected contact target information or agent information, then the processor 210 does not display the additional information setting screen 610, but rather, displays a screen 612 including a contacts list on the display unit 203, wherein the contacts list includes the selected contact target information.

In exemplary embodiments of FIGS. 4 and 5, the additional information setting screen 610 of FIG. 6 may be provided according to whether additional information setting is requested for selected contact target information.

After the first contact target information including the user-selected agent information is added to the contacts list in operation S302, then, in operation S303, selection of second contact target information, including the user-selected agent information according to the contacts list, is sensed. Next, in operation S304, the processor 210 performs the agent service with respect to the user's input information of the electronic device 100 by using a communication channel with the contact server 110 according to the selected second contact target information.

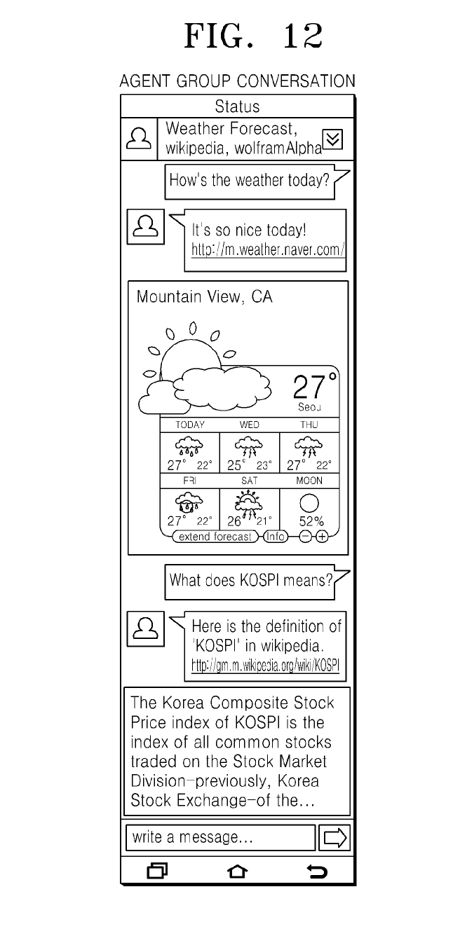

The second contact target information may indicate information of a contact target that is selected for the agent service. The second contact target information may include the information of at least one agent, or the information of at least one agent and information of the acquaintance's electronic device 130 of at least one acquaintance. The information of the acquaintance's electronic device 130 of at least one acquaintance may be referred to as information of at least one acquaintance. As described above, the user's input information of the electronic device 100 may be generated based on the external application of the contacts application. The agent service that corresponds to the user's input information by using the communication channel according to the selected second contact target information are shown in screens illustrated in FIGS. 12, and 14 through 20.

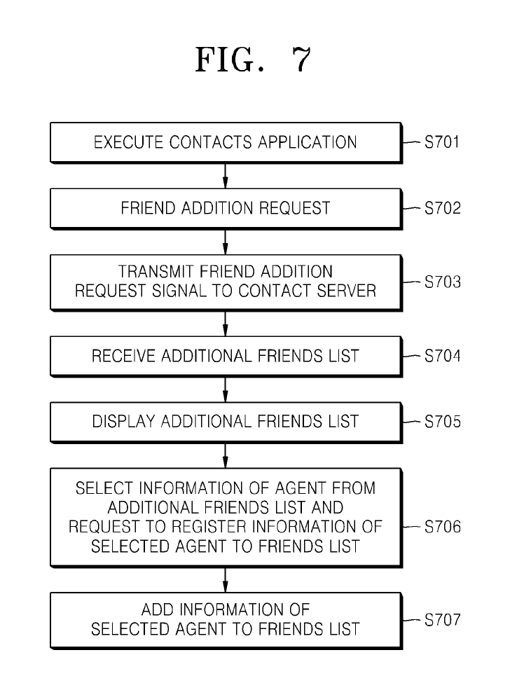

FIG. 7 is a flowchart of a process of adding agent information to contacts list in an agent service method according to an exemplary embodiment of the present invention.

Referring to FIG. 7, the term “friend” or “friends” in FIG. 7 may correspond to the term “contact” in FIG. 3. The process of FIG. 7 may be executed by the processor 210 of FIG. 2. In operation S701, a contacts application is executed in response to a user's request. Next, in operation S702, a friend addition request using a friend addition function included in the contacts application is executed, and then, in operation S703, the processor 210 transmits a friend addition request signal to the contact server 110 via the communication unit 208.

Next, in operation S704, an additional friends list is received from the contact server 110, and then, in operation S705, the processor 210 displays the received additional friends list on the display unit 203. The additional friends list may include information of new friends that are not included in a friends list stored in the storage unit 207 of the electronic device 100. The additional friends list may also include information of at least one agent. The information of at least one agent included in the additional friends list is information of at least one new agent that is not included in the storage unit 207 of the electronic device 100.

In operation S706, selection of the information of at least one agent included in the additional friends list is sensed and it is requested to register the information of the selected agent to the friends list. Next, in operation S707, the processor 210 adds the information of the selected agent to the friends list stored in the storage unit 207.

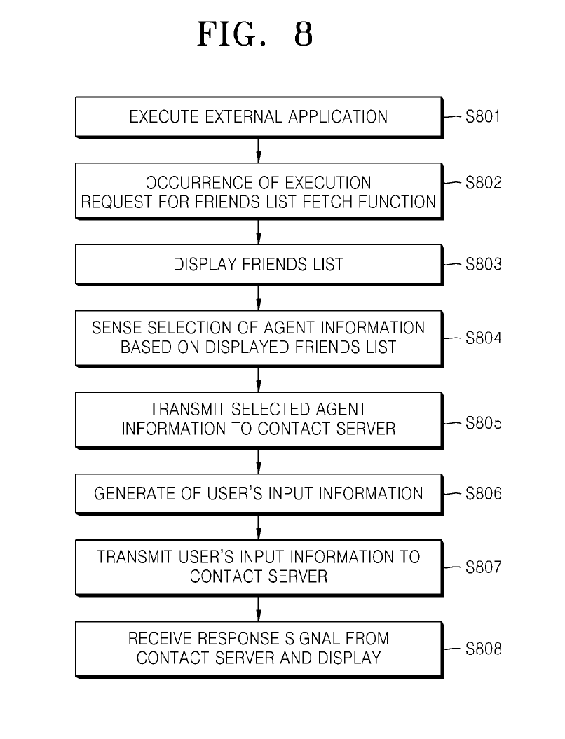

FIG. 8 is a flowchart of an agent service process using a friends list including agent information in an agent service method according to an exemplary embodiment of the present invention.

Referring to FIG. 8, the term “friend” or “friends” in FIG. 8 may correspond to the term “contact” in FIG. 3. The process of FIG. 8 may be executed by the processor 210 of FIG. 2. In operation S801, an external application that is set in the electronic device 100 having a friends list fetch function is executed, and when an execution request for the friends list fetch function occurs in operation S802, the processor 210 displays a friends list stored in the storage unit 207 on the display unit 203 in operation S803.

After selection of information of at least one agent based on the displayed friends list is sensed in operation S804, then, in operation S805, the processor 210 transmits information of a selected agent to the contact server 110 connected to the electronic device 100. Next, in operation S806, the user's input information is generated based on the external application that is executed by the electronic device 100. Next, in operation S807, the processor 210 transmits the generated user's input information to the contact server 110. Then, a response signal that is received from the contact server 110 and that corresponds to the user's input information is displayed on the display unit 203 in operation S808.

The contact server 110 of FIG. 1 may be an SNS server to which at least one agent is registered. That is, the contact server 110 may be the SNS server in which an account of a user of the electronic device 100 is set and to which the at least one agent is registered, wherein the account is synchronized with the electronic device 100. For example, the SNS server may include servers based on SNSs, including Facebook, Google plus, twitter, me2day, kakao talk, and any other similar and/or suitable SNS. The account of the user includes information such as ID information and a password that are registered by the user when the user joins an SNS.

The contact server 110 transmits the additional contacts list to the electronic device 100 according to the contact addition request received from the electronic device 100. Also, when selected contact target information is received from the electronic device 100, the contact server 110 performs the agent service with respect to the user's input information by using an agent that corresponds to agent information included in the selected contact target information. The selected contact target information received from the electronic device 100 corresponds to the second contact target information described above with reference to FIG. 3.

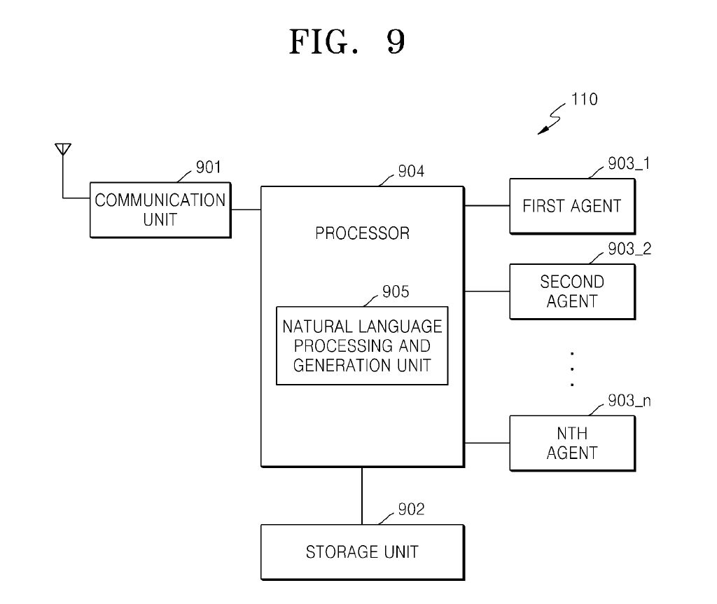

FIG. 9 is a block diagram of a contact server according to an exemplary embodiment of the present invention.

Referring to FIG. 9, a contact server 110 may include a communication unit 901, a storage unit 902, first through nth agents 903_1 through 903_n, and a processor 904. However, the present invention is not limited thereto, and other similar and/or suitable elements may be included in the contact server 110. For example, the contact server 110 may further include a power supply unit. The communication unit 901 communicates with the electronic device 100, the user's external device 120, the acquaintance's electronic device 130, and the acquaintance's external device 140 via the wired network or the wireless network described with reference to the communication unit 208 of FIG. 2.

The storage unit 902 stores information of the first through nth agents 903_1 through 903_n, information of a member registered to the contact server 110, and one or more programs to be executed by the processor 904. When the contact server 110 is an SNS server, the information of the member registered to the contact server 110 indicates information of a member that has joined an SNS. The information of the member may include a telephone number, an e-mail address, and other similar information. The information of the member may be referred to as profile information of the member. When the contact server 110 shares member information with a plurality of SNS servers, the information of the member included in the storage unit 902 may include member information of the plurality of SNS servers. Similar to the storage unit 207 of FIG. 2, the storage unit 902 may be formed as a memory.

The first through nth agents 903_1 through 903_n include agents capable of performing agent services. For example, the first through nth agents 903_1 through 903_n may include various agents such as an agent that has an encyclopedia function such as Wikipedia, an agent that controls a function of the user's external device 120, a translation agent, an agent that controls a function of the acquaintance's external device 140, an agent that collects information from the acquaintance's external device 140, a calculation agent, and any other similar and or suitable agent. The agents may be registered to the contact server 110 by agent developers.

The processor 904 is a controller that controls overall functions of the contact server 110. According to the agent addition request received via the communication unit 901, the processor 904 provides an additional contacts list to the electronic device 100. The additional contacts list includes acquaintance information and agent information that are not registered to the contacts list stored in the electronic device 100.

For this operation, after the processor 904 provides the additional contacts list to the electronic device 100, the processor 904 may receive the acquaintance information and the agent information that are added to the contacts list in the electronic device 100 from the electronic device 100, and may manage the additional contacts list to be provided to the electronic device 100, according to the received acquaintance information and agent information. However, the additional contacts list may be determined by periodical synchronization between the contacts list stored in the storage unit 207 of the electronic device 100 and the contacts list stored in the storage unit 902 of the contact server 110. The periodical synchronization may be performed in a unit of the electronic device 100.

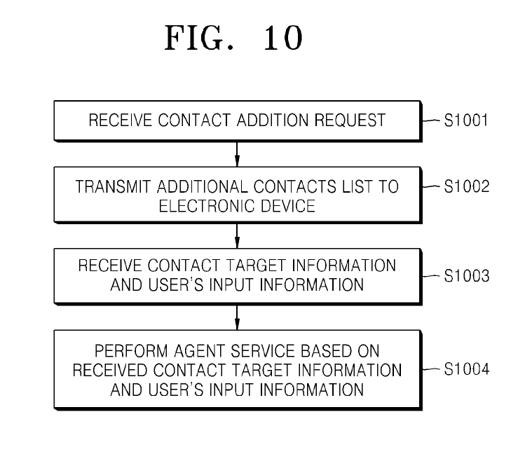

When contact information and the user's input information are received from the electronic device 100 via the communication unit 901, the processor 904 performs an agent service based on the received contact information and user's input information. The processor 904 may execute a program as shown in a flowchart of FIG. 10.

FIG. 10 is a flowchart of an agent service method performed by a contact server according to an exemplary embodiment of the present invention.

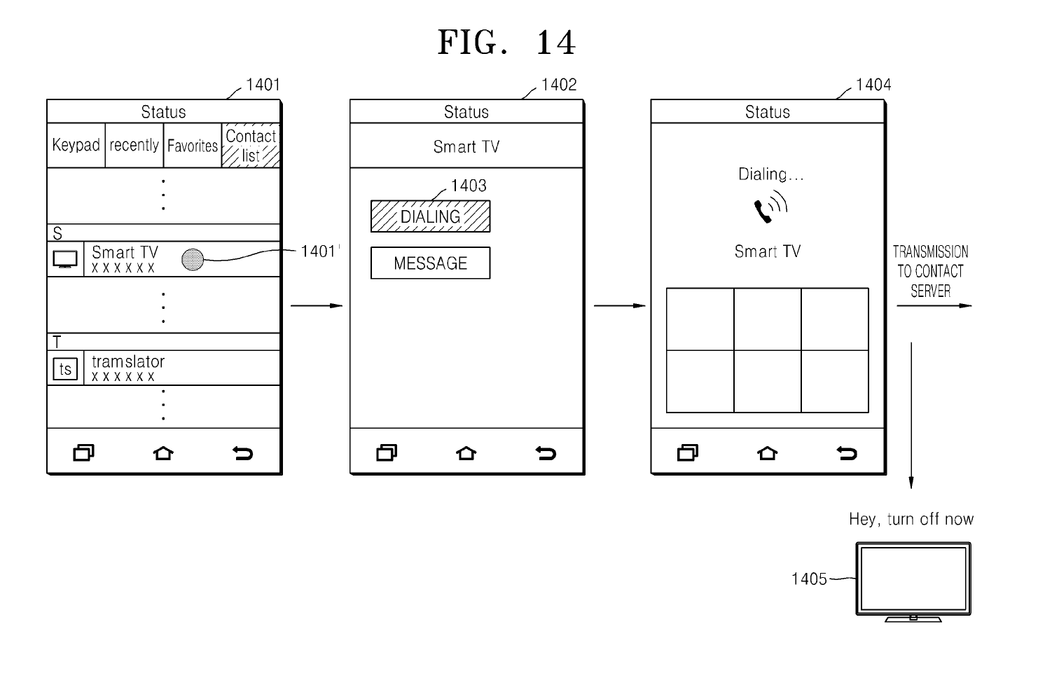

Referring to FIG. 10, a contact addition request is received via the communication unit 901 in operation S1001, and then, in operation S1002, the processor 904 transmits an additional contacts list stored in the storage unit 902 to the electronic device 100 via the communication unit 901. Next, in operation S1003, contact target information and the user's input information are received from the electronic device 100. Then, in operation S1004, the processor 904 detects a contact target from the received contact target information and performs an agent service by transmitting the user's input information to an agent that corresponds to agent information included in the detected contact target. The agent service is shown in FIG. 12, and FIGS. 14 through 20.

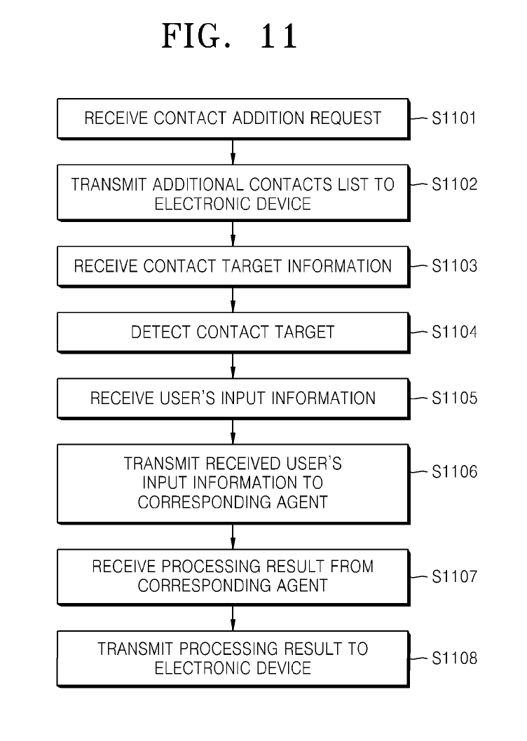

FIG. 11 is a flowchart of an agent service method performed by a contact server according to an exemplary embodiment of the present invention.

Referring to FIG. 11, in operation S1101, a contact addition request is received via the communication unit 901, and, then, in operation S1102, the processor 904 transmits an additional contacts list stored in the storage unit 902 to the electronic device 100 via the communication unit 901. Next, in operation S1103, the contact target information is received from the electronic device 100, and then, in operation S1104, the processor 904 detects a contact target from the received contact target information. The detection of the contact target may include a process of determining whether the contact target is an agent or an acquaintance according to user-selected contact target included in the received contact target information, and a process of determining a type of the agent when the contact target is the agent.

The user's input information is received from the electronic device 100 via the communication unit 901 in operation S1105, and then, in operation S1106, the processor 904 performs natural language processing on the received user's input information and then, transmits the natural language processed user's input information to an agent that corresponds to the detected contact target. Next, in operation S1107, the processor 904 receives a processing result from the corresponding agent. Next, in operation S1108, the processor 904 performs natural language generation on the received processing result and then, transmits the natural language generated processing result to the electronic device 100 via the communication unit 901. The natural language processing and the natural language generation may be similar to and/or the same as those described above. For the natural language processing and the natural language generation, the processor 904 may include a natural language processing and generation unit 905 as shown in FIG. 9.

FIG. 11 corresponds to a case in which the contact target selected by the user is the agent. However, the present invention is not limited thereto, and the flowchart of the agent service method of FIG. 11 may be modified so that, when the contact target selected by the user includes the acquaintance's electronic device 130, the user's input information that is received from the electronic device 100 may be transmitted to at least one of the agent and the acquaintance's electronic device 130, and the processing result by the agent may be transmitted to at least one of the acquaintance's electronic device 130 and the electronic device 100 of the user.

The network 150 of FIG. 1 may be configured as the wired network or the wireless network which is stated above with reference to the communication unit 208 of FIG. 2, and the communication unit 901 of FIG. 9.

Referring to FIG. 1, the agent service based on FIG. 1 may include the following exemplary services L1 through L5, but is not limited thereto:

L1 service: agent service based on a communication channel between one or more agents included in the electronic device 100 and the contact server 110;

L2 service: agent service based on a communication channel from among one or more agents included in the electronic device 100 and the contact server 110, and the user's external device 120;

L3 service: agent service based on a communication channel from among one or more agents included in the electronic device 100 and the contact server 110, and the acquaintance's electronic device 130;

L4 service: agent service based on a communication channel from among one or more agents included in the electronic device 100 and the contact server 110, and the acquaintance's external device 140; and

L5 service: agent service based on a communication channel from among one or more agents included in the electronic device 100 and the contact server 110, the acquaintance's electronic device 130, and the acquaintance's external device 140.

In the exemplary services L1 through L5, the communication channel may refer to a line capable of transmitting and receiving data between devices in a wired or wireless manner. The acquaintance may refer to a person whose contact information is registered in the contacts list stored in the electronic device 100. As described above, the contacts list may be defined according to a contacts application. For example, when the contacts application is a telephone book application, the contacts list may be an acquaintance list including telephone numbers of acquaintances. The acquaintance may be referred to as a friend.

In the exemplary services L1 through L5, at least one piece of agent information registered to the contact server 110 is added to the contacts list stored in the electronic device 100, and then the information of the acquaintance's electronic device 130 and the at least one piece of agent information are used, wherein the at least one piece of agent information is selected based on the contacts list to which the at least one piece of agent information is added. Thus, in the exemplary services L1 through L5, a user-selected contact target includes at least one agent, or the at least one agent and the acquaintance's electronic device 130. The user-selected contact target may refer to a communication target or to a participant which may be contactable via online communication.

The user's external device 120 may be used when the at least one agent included in the user-selected contact target performs an agent service via the communication channel with the user's external device 120. The acquaintance's external device 140 may be used when the at least one agent included in the user-selected contact target performs an agent service via the communication channel with the acquaintance's external device 140. Hereinafter, the examples of the agent service will be described in detail.

The exemplary service L1 may correspond to a case in which the user-selected contact target is at least one agent included in the contact server 110. Here, the selected agent may have a function to answer user's input information or to answer a user's question. For example, the selected agent may have a function as an encyclopedia so as to provide an answer to the user's question. That is, as illustrated in a screen example of FIG. 12, when the selected agent includes a weather forecast agent, a Wikipedia agent, and a Wolfram Alpha agent, processing results generated by agents corresponding to the user's question are displayed on the display unit 203 of the electronic device 100.

FIG. 12 illustrates an example of a screen based on an agent service method according to an exemplary embodiment of the present invention.

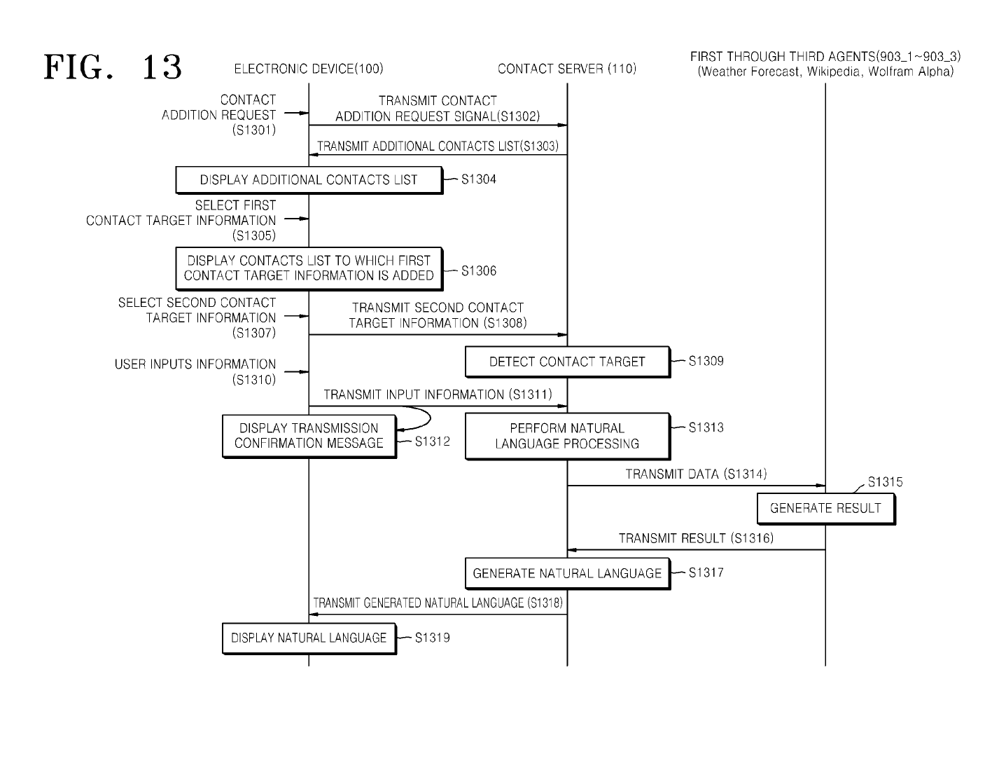

Referring to FIG. 12, in order to allow the processing results generated by the corresponding agent to be displayed on the display unit 203 of the electronic device 100, a process executed by at least one of the electronic device 100, the contact server 110, and the weather forecast agent, the Wikipedia agent, and the Wolfram Alpha agent in the contact server 110 may be performed as shown in FIG. 13.

FIG. 13 illustrates the process based on FIG. 1, which corresponds to a case in which a contact target includes only an agent as shown in FIG. 12.

Referring to FIG. 13, in operation S1301, when a contact addition request by a user of the electronic device 100 occurs, then, in operation S1302, the electronic device 100 transmits a contact addition request signal to the contact server 110. Accordingly, an additional contacts list is transmitted from the contact server 110 to the electronic device 100 in operation S1303.

The electronic device 100 displays the received additional contacts list in operation S1304. When selection of first contact target information occurs based on the displayed additional contacts list in operation S1305, then the electronic device 100 displays a contacts list to which the first contact target information is added in operation S1306. The first contact target information indicates information of a contact target that the user wants to add to the contacts list and that is from among a plurality of pieces of contact target information included in the additional contacts list. Operation S1306 may be modified so that the first contact target information is added to the contacts list, and when an external application is executed by the electronic device 100 and then, the contacts list is requested, the contacts list including the first contact target information is displayed.

When selection of second contact target information occurs while the contacts list including the first contact target information is displayed in operation S1307, then the electronic device 100 transmits the selected second contact target information to the contact server 110 in operation S1308. The contact server 110 detects a contact target from the received second contact target information in operation S1309. According to the exemplary embodiment of FIG. 13, the received second contact target information may include information of the agent as shown in FIG. 12, and thus, the contact server 110 may detect the weather forecast agent, the Wikipedia agent, and the Wolfram Alpha agent as the contact target. When the user inputs information in operation S1310, then the electronic device 100 transmits the user's input information to the contact server 110 in operation S1311 and then displays a transmission confirmation message on the electronic device 100 in operation S1312.

The contact server 110 performs natural language processing on the user's input information in operation S1313, and natural language processed data corresponding to the user's input information to agents, such as the first through third agents 903_1 through 903_3, in operation S1314. As discussed above, FIG. 12 corresponds to a case in which the external application is a text message transmission application, and the user's input information is a text message in a natural language. Thus, the natural language processing and generation unit 905 in the processor 904 performs natural language processing and natural language generation on the user's input information before transmitting the user's input information to the first through third agents 903_1 through 903_3. The first through third agents 903_1 through 903_3 generate results with respect to the natural language processed data in operation S1315. The results generated by the first through third agents 903_1 through 903_3 are transmitted to the contact server 110 in operation S1316. The contact server 110 performs natural language generation processing on the results received from the first through third agents 903_1 through 903_3 in operation S1317, and then, in operation S1318, transmits the results to electronic device 100. Next, in operation S1319, the electronic device 100 displays the screen in the natural language, as shown in FIG. 12.

In the exemplary service L1, the selected agent may have a function to control an application stored in the electronic device 100 of the user. For example, the selected agent may have a function to control a calendar management application set in the electronic device 100 of the user. When the selected agent has the function to control the calendar management application, and the user's input information is calendar information, the selected agent may store the calendar information in the calendar management application that is stored in the electronic device 100 of the user.

The exemplary service L2 corresponds to a case in which the user-selected contact target is at least one agent included in the contact server 110. Here, the selected agent may have a function to control a function of the user's external device 120 according to user's input information. For example, when the user's external device 120 is a TV of the user, the selected agent may control a power on/off, a volume up/down, a channel up/down, and the like according to the user's input information or a user's command. However, examples of the control with respect to the user's external device 120 are not limited thereto and may be any suitable and or similar control of the user's external device 120.

FIG. 14 illustrates examples of other screens based on an agent service method according to another exemplary embodiment of the present invention.

Referring to FIG. 14, examples of screens of a case in which the user's external device 120 is a smart TV, and an agent to control the smart TV that is the user's external device 120 is selected as a second contact target are illustrated. When an input 1401′ for a selection of the smart TV is sensed in a contacts list screen 1401, the processor 210 of the electronic device 100 displays a screen 1402 on the display unit 203, wherein the screen 1402 includes information of the selected smart TV and information regarding selection of communication methods, such as a phone call or a message, with the smart TV. When selection of a dialing item 1403 is sensed, the processor 210 displays a dialing application execution screen 1404 on the display unit 203 while the processor 210 executes a dialing application, and transmits the selection to the contact server 110.

Accordingly, a communication channel is set from among a smart TV control agent in the contact server 110, the electronic device 100, and the user's external device 120, and when user's input information, such as “Hey, turn off now”, occurs in the electronic device 100, a power-off control signal is transmitted from the smart TV control agent in the contact server 110 to the smart TV that is the user's external device 120. Accordingly, a power of a smart TV 1405 is turned off

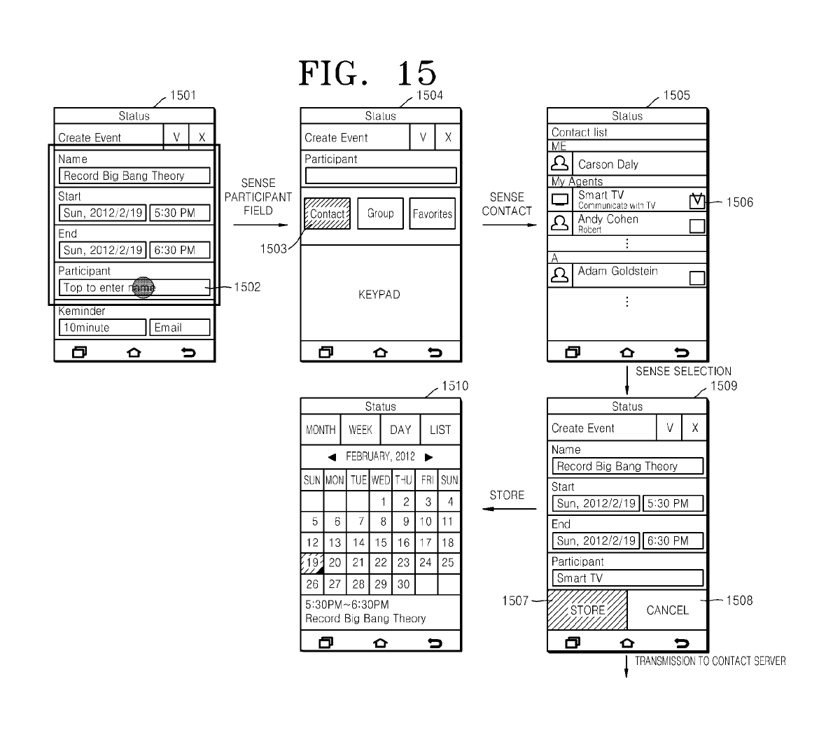

FIGS. 15 through 20 illustrate examples of other screens based on an agent service method according to another exemplary embodiment of the present invention.

Referring to FIG. 15, examples of screens of a case in which programmed recording is set in a TV that is the user's external device 120, by using a calendar management application of the electronic device 100 are illustrated. A screen 1501 of FIG. 15 is a screen on which calendar information is input while the calendar management application of the electronic device 100 is executed, and then a tap is sensed in a participant field 1502. As the tap is sensed in a participant field 1502, a screen 1504 including an item 1503 for fetching a contacts list is displayed on the display unit 203. When the item 1503 is sensed, a screen 1505 including the contacts list is displayed on the display unit 203.

In the screen 1505 of FIG. 15, when a smart TV selection 1506 is sensed, “Smart TV” information is input to a participant field, and a screen 1509 including a ‘store’ item 1507 and a ‘cancel’ item 1508 is displayed on the display unit 203. When selection of the ‘store’ item 1507 is sensed in the screen 1509, the processor 210 transmits reservation recording information to the user's external device 120 via a smart TV control agent by transmitting the input calendar information to the contact server 110, registers the reservation recording information to the calendar management application of the electronic device 100, and displays a registration result screen 1510 on the display unit 203. Accordingly, the smart TV records “Bing Bang Theory” between 5:30-6:30 PM on Feb. 19, 2012. Reservation recording channel information may be input to a field enabled for a calendar management memo input and then may be transmitted to the user's external device 120 via the smart TV control agent.

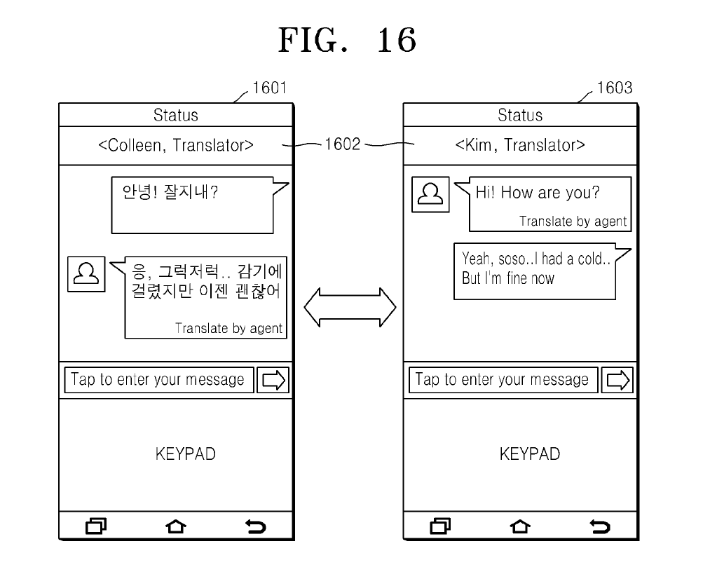

The exemplary service L3 corresponds to a case in which the user-selected contact target includes at least one agent included in the contact server 110, and the acquaintance's electronic device 130. Here, the selected agent may have a function to support conversation between the user and an acquaintance. For example, when the user and the acquaintance talk to each other in different languages, the selected agent may have a function to translate the conversation. FIG. 16 illustrates examples of screens of a case in which text messages are exchanged between the electronic device 100 and the acquaintance's electronic device 130, and a translation agent registered to the contact server 110 is selected because they use different languages. A screen 1601 is displayed on the display unit 203 of the electronic device 100, and a screen 1603 is displayed on the acquaintance's electronic device 130. Each of the screens 1601 and 1603 includes a field 1602 that shows a current conversation target.

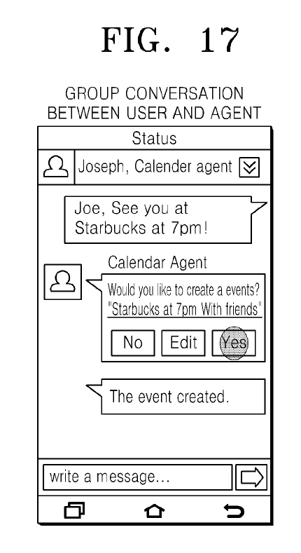

In the exemplary service L3, the selected agent may have a function to recommend an event related to calendar information included in the conversation between the user and the acquaintance. A screen example of FIG. 17 corresponds thereto. In the screen example of FIG. 17, an acquaintance, such as Joseph, or an acquaintance's electronic device, and a calendar agent to control calendar management applications of the electronic device 100 is selected as a contact target. The calendar agent that controls the calendar management application recommends an event with respect to a text message from the acquaintance's electronic device, and when the user selects the recommended event, the calendar agent may notify of event generation and then may update calendar information of the electronic device 100 and the acquaintance's electronic device.

The exemplary service L4 corresponds to a case in which the user-selected contact target is at least one agent included in the contact server 110. Here, the selected agent may have a function to control a function of the acquaintance's external device 140 of at least one acquaintance according to user's input information. For example, the selected agent may control a power on/off, a volume up/down, a channel up/down, and the like with respect to the acquaintance's external device 140, according to the user's input information or a user's command. However, examples of the control with respect to the acquaintance's external device 140 are not limited thereto, and the control of the acquaintance's external device 140 may be any suitable and/or similar control.

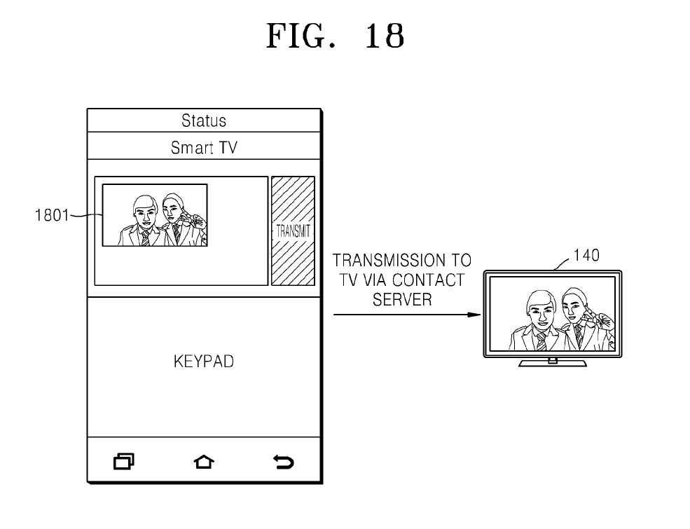

FIG. 18 illustrates screens of a case in which an agent to control a smart TV of an acquaintance, which is the acquaintance's external device 140, is selected as a contact target, and then an image 1801 is transmitted to the smart TV of the acquaintance, which is the acquaintance's external device 140, by executing a message transmission application of the electronic device 100.

In another example of the exemplary service L4, as illustrated in FIG. 19, the user-selected contact target may be an agent to provide information collected from the acquaintance's external device 140. That is, the selected agent may have a function to provide the information, such as health care information, collected from the acquaintance's external device 140 in response to user's input information or a user's question. Here, the user's input information may include information related to designation of an agent by inputting “@Agent”.

The exemplary service L5 corresponds to a case in which the user-selected contact target includes at least one agent included in the contact server 110, and the acquaintance's electronic device 130. Here, the selected agent may have a function to control the acquaintance's external device 140 during conversation between the electronic device 100 and the acquaintance's electronic devices 130.

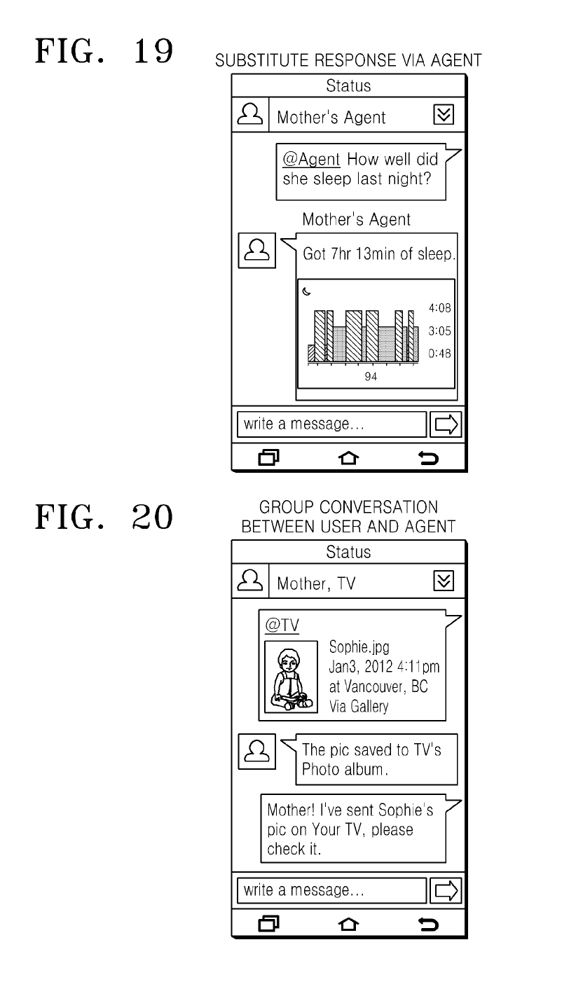

FIG. 20 illustrates a screen of a case in which a contact target is selected as the exemplary service L5 of the agent service according to an exemplary embodiment of the present invention.

Referring to FIG. 20, the contact target is an agent to control a mother's TV and a mother's electronic device. First, a text message application of the electronic device 100 is executed and then, an album is transmitted via the agent that controls the mother's TV. When a message informing that the album is stored in the mother's TV is received from the agent, the user transmits a confirmation message to the mother's electronic device that is the acquaintance's electronic device 130.

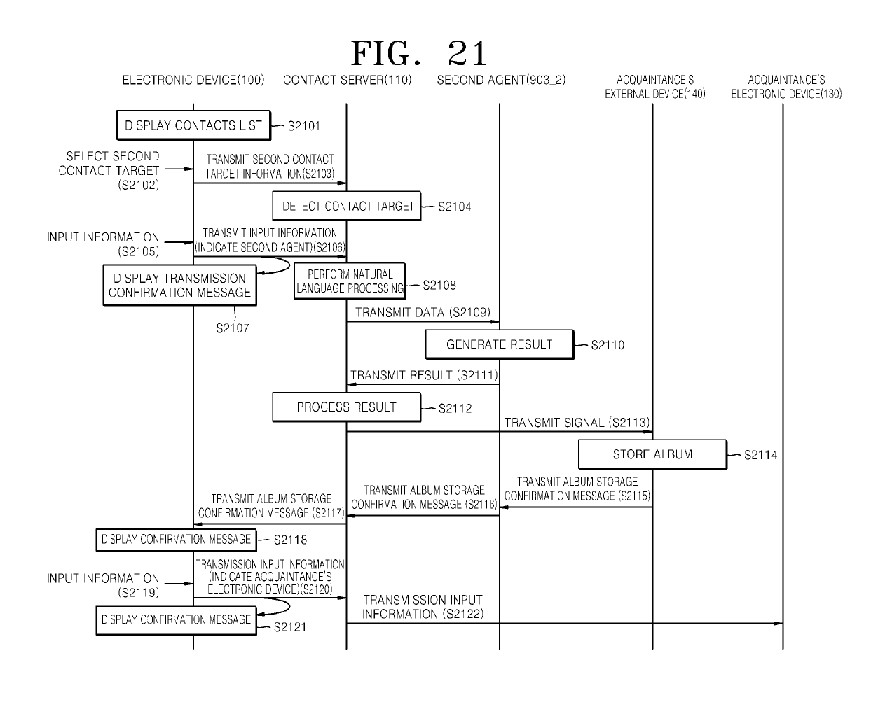

FIG. 21 illustrates a process based on FIG. 1 when the agent service shown in FIG. 20 is performed.

Referring to FIGS. 21 and 13, when the contacts list to which the first contact target information is added, via operations S1301 through S1305 of FIG. 13, is displayed on the electronic device 100 in operation S2101, and if selection of second contact target information occurs in operation S2102, then the electronic device 100 transmits the selected second contact target information to the contact server 110 in operation S2103.

The contact server 110 detects a contact target from the received second contact target information in operation S2104. In the case of FIG. 20, the received second contact target information includes the agent to control the mother's TV, which may be the second agent 903_2, and the mother's electronic device, which may be the acquaintance's electronic device 130. Thus, in operation S2104, the contact server 110 detects the second agent 903_2 and the acquaintance's electronic device 130 as the contact target.

When the user inputs information in operation S2105, then the electronic device 100 transmits the user's input information to the contact server 110 in operation S2106 and displays a transmission confirmation message on the electronic device 100 in operation S2107. The user's input information that is transmitted to the contact server 110 includes information indicating the second agent 903_2. Thus, the contact server 110 performs natural language processing on the user's input information in operation S2108 and then, in operation S2109, transmits it to the second agent 903_2.

The second agent 903_2 generates a processing result with respect to the received user's input information in operation S2110 and transmits the result to the contact servicer 110 in operation S2111. Because FIG. 20 corresponds to the case in which the album is transmitted to the mother's TV, the processing result generated by the second agent 903_2 is a signal used to transmit information of the album to the acquaintance's external device 140. The contact server 110 performs natural language processing on the processing result generated by the second agent 903_2 in operation S2112. The contact server 110 transmits a natural language processed result to the acquaintance's external device 140 in operation S2113. In operation S2113, the signal may be transmitted via the communication unit 901 in the contact server 110.

Accordingly, the album is stored in the mother's TV, which is the acquaintance's external device 140, in operation S2114, and then a confirmation message indicating completion of a storing operation is transmitted from the acquaintance's external device 140 to the second agent 903_2 in operation S2115. The confirmation message indicating completion of a storing operation may also be transmitted via the communication unit 901 in the contact server 110.

The second agent 903_2 transmits the confirmation message to the communication unit 901 in the contact server 110 in operation S2116, and then on to the electronic device in operation S2117. Here, the transmitted confirmation message may have undergone a natural language generation process by the natural language processing and generation unit 905.

The electronic device 100 displays the confirmation message (“The pic was saved in the TV's Photo album”) on the display unit 203, as illustrated in FIG. 20, in operation S2118. When the user's next input information, such as “Mother! I've sent . . . ”, is inputted in operation S2119, then the electronic device 100 transmits the next user's input information to the contact server 110 in operation S2120, and then proceeds to display a confirmation message on the electronic device 100 in operation S2121. Here, the user's next input information may include indication information with respect to the acquaintance's electronic device 130, which informs that the user's next input information is input information that is transmitted to the acquaintance's electronic device 130. Accordingly, the contact server 110 transmits the received user's next input information to the mother's electronic device, which is the acquaintance's electronic device 130, in operation S2122.

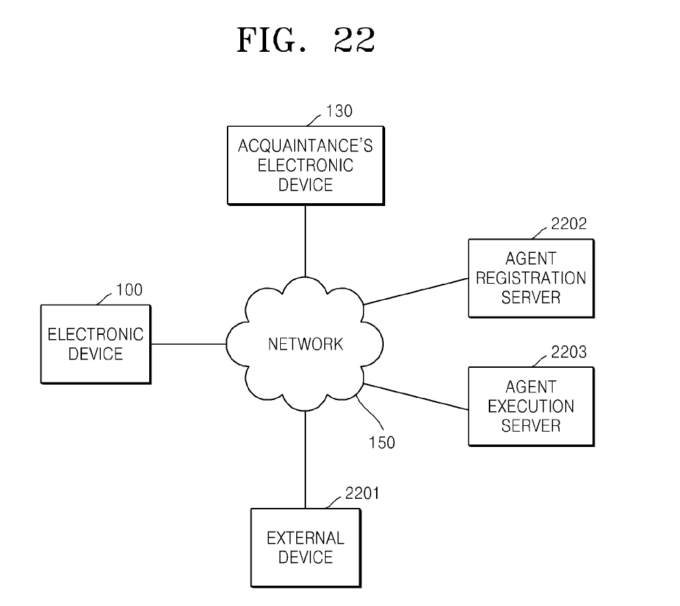

FIG. 22 illustrates a network configuration arranged to provide an agent service according to another exemplary embodiment of the present invention.

Referring to FIG. 22, the network configuration includes an electronic device 100, an acquaintance's electronic device 130, a network 150, an external device 2201, an agent registration server 2202, and an agent execution server 2203. The electronic device 100, the acquaintance's electronic device 130, and the network 150 are the same as the electronic device 100, the acquaintance's electronic device 130, and the network 150 of FIG. 1, respectively. Here, a communication unit 208 of the electronic device 100 may communicate with at least one agent registration server 2202 and at least one agent execution server 2203 via the wired network or the wireless network, instead of communicating with the contact server 110.

The external device 2201 may include the user's external device 120 and the acquaintance's external device 140. The agent registration server 2202 may be a server having a function to provide agent registration information from among the functions of the contact server 110. The agent execution server 2203 may include functions related to the first through nth agents 903_1 through 903_n from among the functions of the contact server 110. Alternatively, the agent execution server 2203 may include a function related to one of the first through nth agents 903_1 through 903_n. That is, the agent execution server 2203 may include n agent execution servers that correspond to the first through nth agents 903_1 through 903_n, respectively. Thus, the electronic device 100 may register at least one agent to a contacts list, based on connection with the agent registration server 2202, and may perform an agent service, based on the connection with the agent registration server 2202.

Although not illustrated, the electronic device 100 may selectively download one or more agents registered to the contact server 110, in response to a user request, and then, may perform agent services. In this case, when the agent services are performed, the electronic device 100 may be not connected to the contact server 110 or the agent execution server 2203.

At least one program, including the agent service method according to the one or more embodiments of the present invention, and commands to perform the agent service method by using a computer, can also be embodied as computer-readable codes on a non-transient computer-readable recording medium. The non-transient computer-readable recording medium may be any data storage device that can store data which can be thereafter read by a computer system. Examples of the non-transient computer-readable recording medium may include Read-Only Memory (ROM), Random-Access Memory (RAM), CD-ROMs, magnetic tapes, floppy disks, optical data storage devices, etc. The non-transient computer-readable recording medium may also be distributed over network-coupled computer systems so that the computer-readable code is stored and executed in a distributed fashion.

While the present invention has been shown and described with reference to exemplary embodiments thereof, it will be understood by those skilled in the art that various changes in form and details may be made therein without departing from the spirit and scope of the present invention as defined by the following claims and their equivalents.

What is claimed is:

1. An agent service method in an electronic device, the agent service method comprising:
displaying an additional contacts list that is received from at least one of at least one contact server and at least one agent registration server in response to a contact addition request using the electronic device;
adding first contact target information to a contacts list of the electronic device in response to a registration request for the first contact target information that is selected from among the additional contacts list; and
performing an agent service with respect to user's input information of a user of the electronic device via a communication channel between the electronic device and the at least one contact server or between the electronic device and the at least one agent executing server according to second contact target information that is selected from the contacts list,
wherein each of the additional contacts list, the first contact target information, and the second contact target information comprises at least one piece of agent information.

2. The agent service method of claim 1, wherein the displaying of the additional contacts list and the adding of the first contact target information are performed by executing a contacts application that is set in the electronic device,
wherein the performing of the agent service is performed by executing an external application of the contacts application,
wherein the external application is set in the electronic device and has a function to fetch the contacts list, and
wherein the user's input information is generated according to the external application.

3. The agent service method of claim 2, wherein the contacts application is synchronized with a friend addition request of at least one Social Network Service (SNS) in the contact addition request.

4. The agent service method of claim 1, wherein the user's input information comprises at least one of a natural language-based text message, a natural language-based voice signal, and multimedia information.

5. The agent service method of claim 1, wherein the agent service is based on a function of an agent that corresponds to agent information comprised in the second contact target information and that is comprised in the at least one contact server or the at least one agent executing server.

6. The agent service method of claim 1, wherein the at least one contact server comprises at least one Social Network Service (SNS) server in which an account of the user of the electronic device is set, and
wherein the account is synchronized with the electronic device.

7. The agent service method of claim 1, wherein the adding of the first contact target information to a contacts list of the electronic device comprises displaying the contacts list to which the first contact target information is added in response to the registration request.

8. The agent service method of claim 1, wherein the contact addition request is based on an agent addition request.

9. The agent service method of claim 1, wherein the contact addition request is based on a search request using a search keyword.

10. The agent service method of claim 1, wherein the adding of the first contact target information to a contacts list of the electronic device comprises:
displaying an additional information setting screen when at least one additional information setting is required for the at least one piece of agent information that is selected to be added to the contacts list;
linking information, which is input according to the additional information setting screen, with the at least one piece of selected agent information, and storing the linked information in the electronic device; and
adding the at least one piece of selected agent information to the contacts list, without displaying the additional information setting screen, when the additional information setting is not required for the at least one piece of agent information that is selected to be added to the contacts list,
wherein the additional information includes information that is used to set the communication channel.

11. An agent service method in a mobile terminal, the agent service method comprising:
registering at least one piece of agent information to a friends list included in the mobile terminal by using a friend addition function of a contacts application that is set in the mobile terminal, the at least one piece of agent information being registered in at least one of at least one Social Network Service (SNS) server and at least one agent registration server;
executing an external application of the contacts application, and retrieving the friends list; and
performing an agent service with respect to user's input information according to the external application via a communication channel between the mobile terminal and at least one agent that is based on the at least one piece of agent information selected from the friends list and that is comprised in at least one of the at least one SNS server and the at least one agent executing server.

12. A computer-readable recording medium having recorded thereon at least one program having commands to perform an agent service method in an electronic device, the agent service method comprising:
displaying an additional contacts list that is received from at least one of at least one contact server and at least one agent registration server in response to a contact addition request using the electronic device;
adding first contact target information to a contacts list of the electronic device in response to a registration request for the first contact target information that is selected according to the additional contacts list; and
performing an agent service with respect to user's input information of a user of the electronic device via at least one of a communication channel between the electronic device and the at least one contact server and a communication channel between the electronic device and at least one agent executing server, according to second contact target information that is selected from the contacts list,
wherein each of the additional contacts list, the first contact target information, and the second contact target information comprises at least one piece of agent information.

13. An electronic device comprising:
a display unit for displaying a screen in response to user's input information;
at least one processor for providing a user interface according to the user's input information and the display unit;
a communication unit for communicating with at least one contact server, at least one agent registration server, and at least one agent executing server; and
a storage unit for storing at least one program to be executed by the at least one processor, and a contacts list,
wherein the at least one program comprises:
a command to display an additional contacts list that is received from the at least one contact server or the at least one agent registration server in response to a contact addition request,
a command to add first contact target information to the contacts list in response to a registration request for the first contact target information that is selected from the additional contacts list, and
a command to perform an agent service according to a user's input information via a communication channel with the at least one contact server or with the at least one agent executing server, according to second contact target information that is selected from the contacts list, and
wherein each of the additional contacts list, the first contact target information, and the second contact target information comprises at least one piece of agent information.

14. The electronic device of claim 13, wherein the command to add the first contact target information to the contacts list is performed by executing a contacts application that is set in the electronic device,
wherein the command to perform the agent service is performed by executing an external application of the contacts application,
wherein the external application is set in the electronic device and has a function to fetch the contacts list, and
wherein the user's input information is generated according to the external application.

15. The electronic device of claim 14, wherein the contacts application is synchronized with a friend addition request of at least one Social Network Service (SNS) in the contact addition request.

16. An agent service method in a server, the agent service method comprising:
transmitting an additional contacts list to at least one electronic device in response to a contact addition request signal received from the at least one electronic device; and
performing an agent service with respect to user's input information received from the at least one electronic device by using at least one agent that is from among a plurality of agents and that corresponds to at least one piece of agent information comprised in contact target information received from the at least one electronic device.

17. A server comprising:
a communication unit for communicating with at least one electronic device;
a plurality of agents each performing an agent service with respect to a user's input information that is received via the communication unit;
at least one processor for controlling the communication unit and the plurality of agents; and
a storage unit for storing an additional contacts list and at least one program that is configured to be executed by the at least one processor,
wherein the at least one program comprises one or more commands to transmit the additional contacts list read from the storage unit to the at least one electronic device in response to a contact addition request signal that is received from the at least one electronic device via the communication unit, and
wherein the agent service is performed with respect to a user's input information received from the at least one electronic device, by using at least one agent that is from among the plurality of agents and that corresponds to at least one piece of agent information comprised in contact target information received from the at least one electronic device via the communication unit.

18. An agent service method in a mobile terminal, the agent service method comprising:
executing a contacts application that is set in the mobile terminal;
transmitting a friend addition request signal to at least one of at least one contact server and at least one agent registration server according to a friend addition request using a friend addition function of the contacts application;
receiving an additional friends list from at least one of the at least one contact server and the at least one agent registration server;
displaying the additional friends list on the mobile terminal; and
adding at least one piece of agent information to a friends list stored in the mobile terminal according to a selection and registration request for the at least one piece of agent information comprised in the additional friends list,
wherein the additional friends list comprises at least one new piece of agent information and at least one new piece of friend information.

19. An agent service method in a mobile terminal, the agent service method comprising:
executing an application that is set in the mobile terminal and that includes a friends list retrieve function;
displaying a friends list stored in the mobile terminal according to an execution request for the friends list fetch function;
transmitting at least one piece of agent information to at least one of at least one contact server and at least one agent registration server according to selection of the at least one piece of agent information based on the friends list;
transmitting user's input information according to the executed application to at least one of the at least one contact server and the at least one agent registration server; and
displaying a response signal on the mobile terminal,
wherein the response signal corresponds to a user's input information and is received from at least one of the at least one contact server and the at least one agent registration server.

20. An agent service system comprising:
an electronic device that adds at least one piece of agent information to a contacts list by using an additional contacts list and that performs an agent service by using the at least one piece of agent information selected according to the contacts list;
an agent registration server having a plurality of agents and that transmits an additional contacts list comprising information of the plurality of agents to the electronic device in response to a contact addition request signal received from the electronic device; and
at least one agent execution server that forms a communication channel with the electronic device by using the at least one piece of agent information received from the electronic device, and that provides an agent service with respect to a user's input information received from the electronic device via the communication channel,
wherein the contacts list of the electronic device comprises at least one piece of agent information and at least one piece of acquaintance information.
